(19) United States
(12) Patent Application Publication
(10) Pub. No.: US 2024/0202098 A1
(43) Pub. Date: Jun. 20, 2024

(54) STATIC ANALYSIS FOR SOUND INTERLEAVING PRUNING IN ENUMERATIVE MODEL CHECKING

(71) Applicant: Technology Innovation Institute - Sole Proprietorship LLC, Masdar City (AE)

(72) Inventor: Ridhi Jain, Abu Dhabi (AE)

(73) Assignee: Technology Innovation Institute - Sole Proprietorship LLC, Masdar City (AE)

(21) Appl. No.: 18/082,676

(22) Filed: Dec. 16, 2022

(51) Int. Cl. G06F 11/36

(52) U.S. Cl. CPC G06F 11/3608; G06F 11/3688

(57) ABSTRACT

An example embodiment includes a method for model checking a program. The method includes performing, by a processor, static analysis of source code of the program to inductively determine at least one invariant present in interleavings of by the program, and performing, by the processor, static instrumentation of the source code of program to generate an instrumented equivalent version of the program. The instrumented equivalent version of the program comprises locks to avoid execution of a subset of the interleavings corresponding to the at least one invariant. The instrumented equivalent version of the program is configured for enumerative model checking that avoids execution of the subset of the interleavings.

### FIELD

A system and method for static analysis for sound interleaving pruning in enumerative model checking.

### BACKGROUND

Multithreaded programming often introduces concurrency bugs in the code as a by-product. These concurrency bugs may render the program with exposed security vulnerabilities and make it a candidate for concurrency attacks. A major bottleneck in verifying concurrent software is their ability to exhibit multiple behaviour. These multiple behaviours can be explored and verified via Dynamic Partial Order Reduction (DPOR) techniques. Though providing the soundness and completeness assurances, DPOR techniques are expensive in terms of processing time/power. In addition, the cost of DPOR techniques grows exponentially compared to the number of threads and shared variables making it difficult to scale DPOR-based approaches to real life software.

### SUMMARY

An example embodiment includes a method for model checking a program. The method includes performing, by a processor, static analysis of source code of the program to inductively determine at least one invariant present in interleavings of the program, and performing, by the processor, static instrumentation of the source code of program to generate an instrumented equivalent version of the program. The instrumented equivalent version of the program comprises locks to avoid execution of a subset of the interleavings. The instrumented equivalent version of the program is configured for enumerative model checking that avoids execution of the subset of the interleavings corresponding to the at least one invariant.

An example embodiment includes a system for model checking a program. The system includes a memory device storing source code of a program, and a processor. The processor is configured to execute the model checking program, retrieve the source code of the program from the memory device, perform static analysis of the source code of the program to inductively determine at least one invariant present in interleavings of the program, and perform static instrumentation of the source code of program to generate an instrumented equivalent version of the program. The instrumented equivalent version of the program includes locks to avoid execution of a subset of the interleavings corresponding to the at least one invariant. The instrumented equivalent version of the program is configured for enumerative model checking that avoids execution of the subset of the interleavings.

### BRIEF DESCRIPTION OF THE DRAWINGS

So that the manner in which the above recited features of the present disclosure can be understood in detail, a more particular description of the disclosure, briefly summarized above, may be had by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 shows a block diagram of an automated program instrumentation system, according to an example embodiment of the present disclosure.

FIG. 2A shows a flowchart describing the operation of the automated program instrumentation system in FIG. 1, according to an example embodiment of the present disclosure.

FIG. 2B shows a flowchart describing the static analysis step in FIG. 2A, according to an example embodiment of the present disclosure.

FIG. 2C shows a flowchart describing the static instrumentation step in FIG. 2A, according to an example embodiment of the present disclosure.

FIG. 2D shows a flowchart describing the model checking step in FIG. 2A, according to an example embodiment of the present disclosure.

FIG. 3 shows an example program under test and resultant interleavings, according to an example embodiment of the present disclosure.

FIG. 4 shows an example of creating an instrumented equivalent program of the program under test in FIG. 3, according to an example embodiment of the present disclosure.

FIG. 5 shows a diagram of hardware for implementing the automated program instrumentation system/methods in FIGS. 1-4, according to an example embodiment of the present disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments could have different values. Notice that similar reference numerals and letters refer to similar items in the following figures, and thus once an item is defined in one figure, it is possible that it need not be further discussed for the following figures. Below, the example embodiments will be described with reference to the accompanying figures.

At present, software is an integral part of any aspect of life, be it medical equipment, banking facilities, airplanes, or space shuttles. Consequently, providing the safety and security assurances for such applications is the most desirable feature for any software verifying such applications. Thus, the soundness and completeness properties become a precondition for any verification tool for testing such software.

Software model checking is a method of checking whether the operation (e.g. finite state machine) of a computer program meets a given specification. In other words, model checking determines if the computer program operates as intended by the system designer (e.g. programmer). A popular technique for model checking the operation of programs (e.g. multi-threaded programs) is known as enumerative model checking where the model checking software executes and traverses through the various states of the program under test (PUT) using a run-time scheduler. However, providing both guarantees of soundness and completeness in software is expensive in terms of processing power/time because of the extensive interleavings (sharing of execution time) resulting from multi-threaded programs. In addition, tradeoffs between performance and precision of the model checking software may not be desirable or even possible when dealing with mission-critical real-time software where timing between thread tasks are important.

Furthermore, multithreaded programming for performance gains often introduces concurrency bugs in the code as a by-product. These concurrency bugs may render the program with exposed security vulnerabilities and make it a candidate for concurrency attacks. A major bottleneck in verifying the concurrent software is their ability to exhibit multiple behavior depending on the timing of execution of the threads.

The multiple behaviors present in these multi-threaded programs can be explored and verified by an enumerative model checking technique known as Dynamic Partial Order Reduction (DPOR). However, the processing power/time cost of model checking grows exponentially compared to the number of threads and shared variables making it difficult to scale DPOR-based approaches to real life software. This problem creates a need for scalable sound and complete verification tools.

An aspect of the disclosure offers a hybrid approach to model checking that leverages static prepossessing of the PUT to identify redundant paths and prune the search space at the time of verification to produce an instrumented version of the PUT referred to herein as the “instrumented PUT” without changing the inherent properties of the original PUT. In order to achieve this goal, appropriately placed locks are positioned in the instrumented PUT to automatically prune the search space at the time of verification. The locks preserve the program order such that the model checker can safely ignore some redundant reorderings thereby reducing processing power/time exerted by the enumerative model checker. Essentially, the instrumented PUT can be analyzed by dynamic verification techniques (e.g. DPOR) at a lesser cost of processing time/power while still ensuring accuracy of the verification.

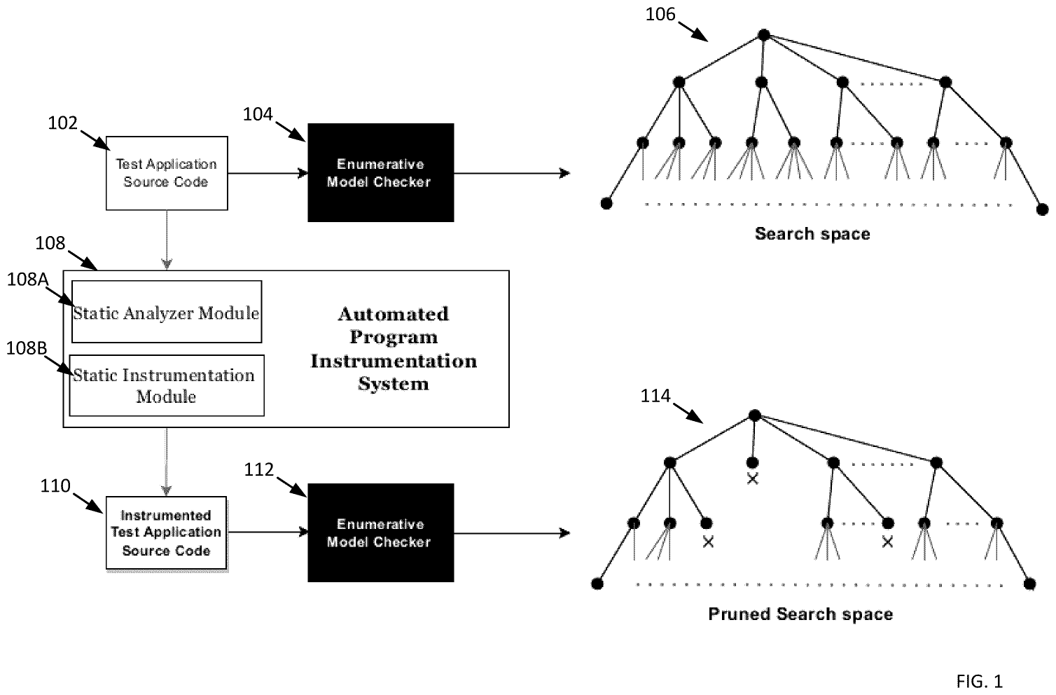

FIG. 1 shows an overall block diagram of the disclosed system/method for analyzing a PUT, creating the instrumented PUT and performing the model checking on the instrumented PUT. Specifically, FIG. 1 includes an automated program instrumentation system 108 having a static analyzer module 108A and static instrumentation model 108B. The automated program instrumentation system 108 is essentially a software application, and the modules are parts of the software application for performing specific analysis and instrumentation tasks.

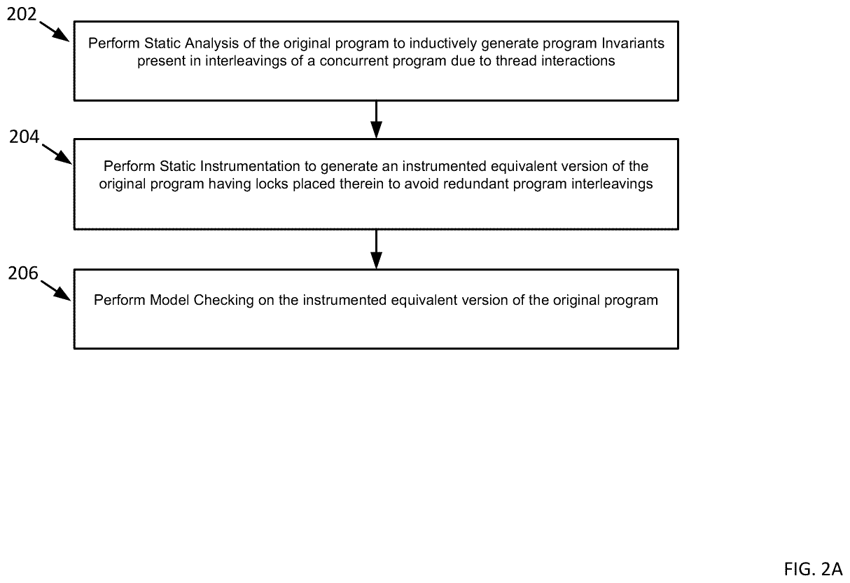

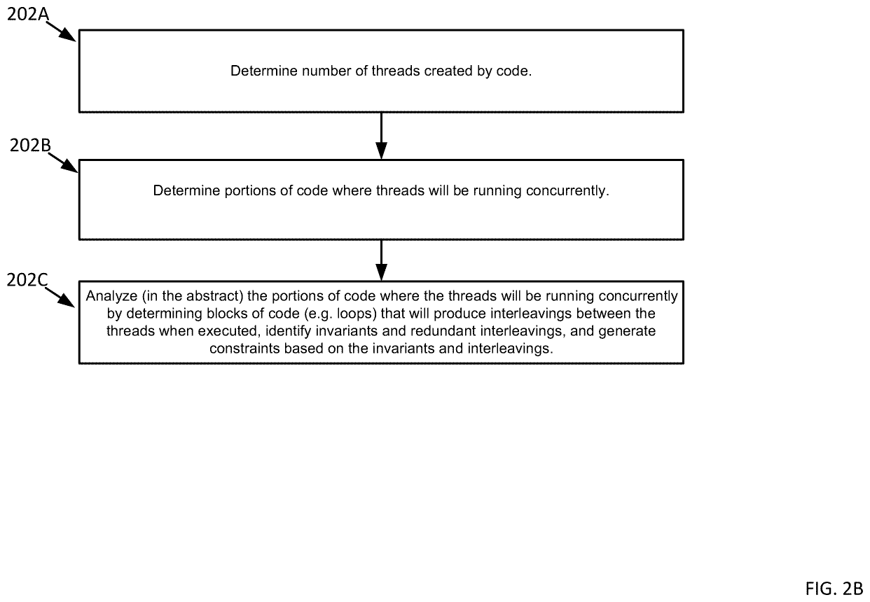

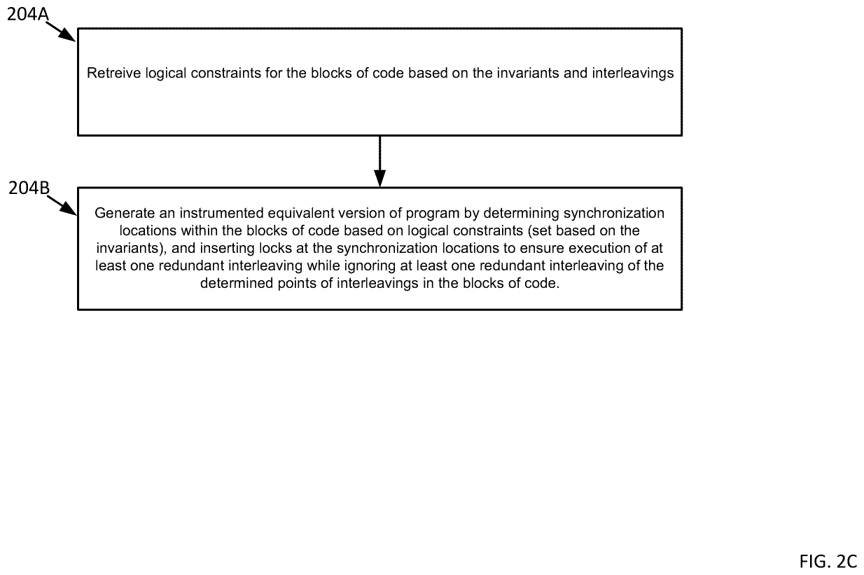

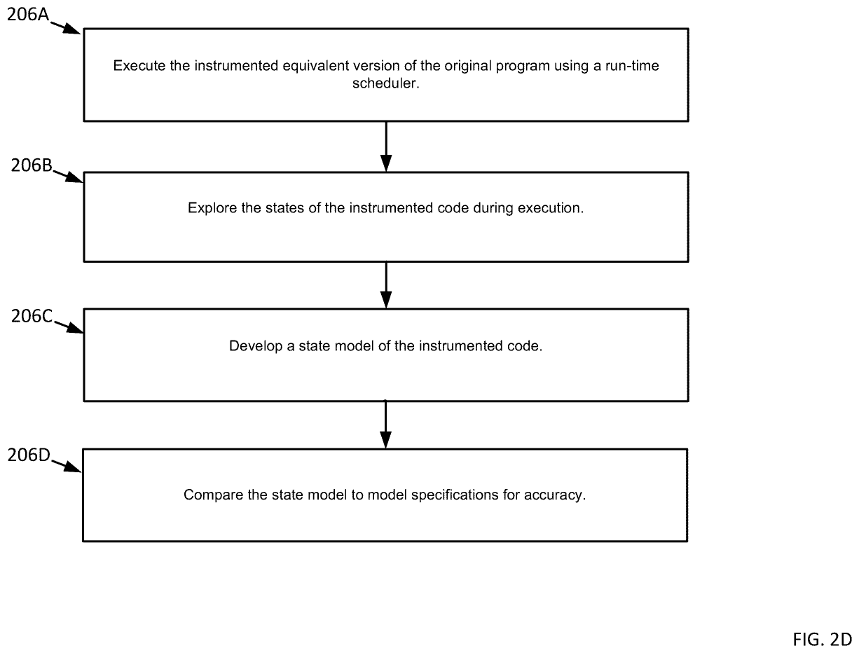

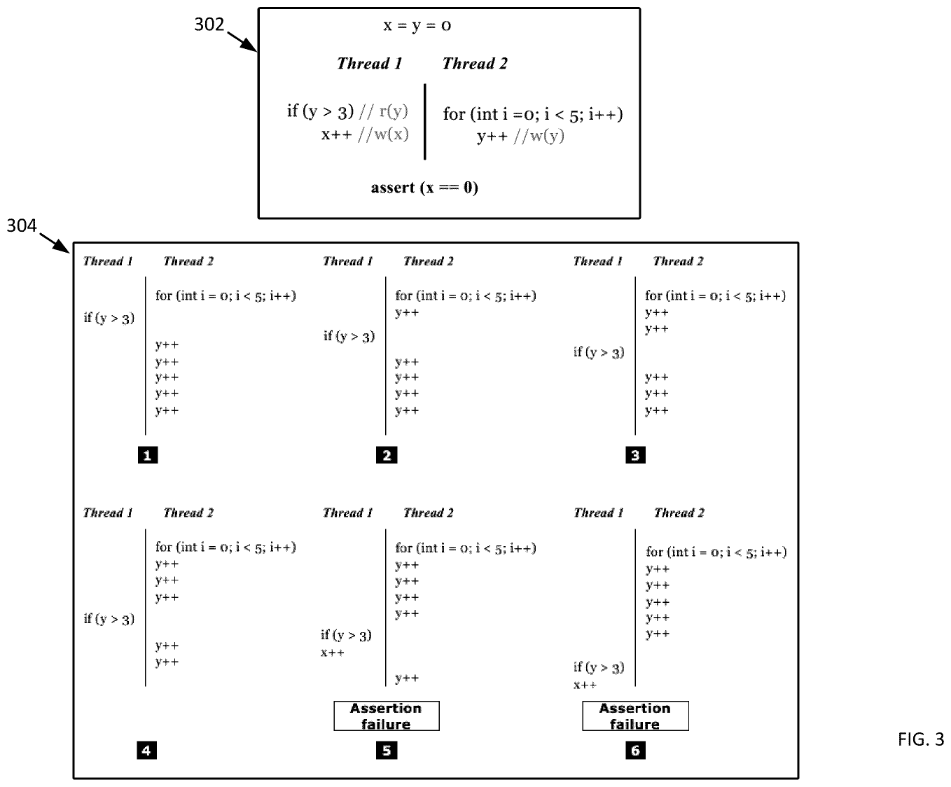

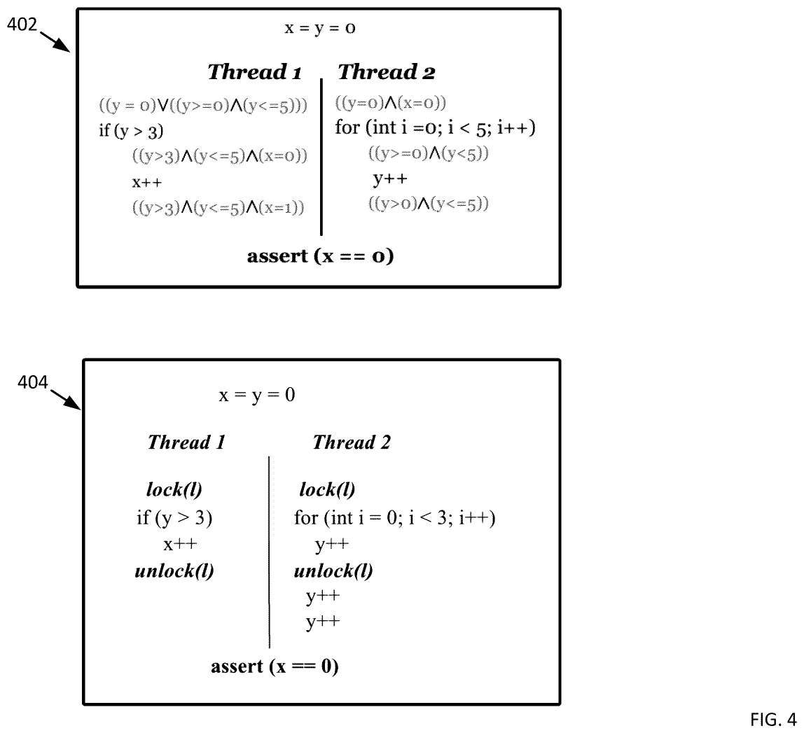

Before discussing the details of the automated program instrumentation system, it should be noted that in conventional model checking methods, PUT 102 would be directly input to an enumerative model checker 104 which would perform model checking by executing and traversing through all of the various states of PUT using a run-time scheduler. However, the state space 106 of the PUT (without any pruning) is large and would consume significant processing time/power to complete the model checking process. Rather than directly inputting the PUT into an enumerative model checker, the disclosed solution first inputs the PUT into automated program instrumentation system 108 to generate an instrumented PUT 110 (e.g. a modified version of the PUT) which is then input to enumerative model checker 112. A benefit to this method is that instrumented PUT 110 includes a pruned state space 114 that is smaller than the original state space 106 of the same PUT. This pruned state space 114 reduces the overall processing time/power required to complete the model checking. Details of automated program instrumentation system 108 will now be described with respect to FIGS. 2A-2D and an example in FIGS. 3-4.

FIG. 2A shows a flowchart describing the overall operation of the automated program instrumentation system 108 and enumerative model checker 112 shown in FIG. 1. The overall process is broken down into three primary steps. In a first primary step, static program analyzer 108A of program instrumentation system 108 performs a static analysis of the PUT without executing the PUT. In general, the static analysis identifies interleavings between the threads and invariants (variables that do not change) through two or more of the interleavings, and generates constraints based on the interleavings and invariants. In a second primary step, static instrumentation module 108B of program instrumentation system 108 performs static instrumentation on the PUT to develop an instrumented PUT with fewer states to check. In general, the static instrumentation modifies the PUT based on the constraints to create the instrumented PUT. In a third primary step, enumerative model checker 112 performs model checking on the instrumented PUT by executing the PUT according to a runtime scheduler. Details of each of these three steps will now be described. Further details of these three primary steps are described below.

As mentioned above, in the first primary step 202 of FIG. 2A, static analyzer module 108A of automated program instrumentation system 108 performs a static analysis of the PUT to inductively determine program invariants present in interleavings of a concurrent program due to the thread interactions, and generating constraints based on the invariants and interleavings. This analysis is performed in the abstract by walking through the code and inductively making these determinations without executing the PUT with a run-time scheduler. First primary step 202 is broken down into three sub steps as shown in FIG. 2B. For example, as shown in step 202A of FIG. 2B, first, static analyzer module 108A analyzes the code and determines a number of threads created by the PUT. This can be accomplished by searching for thread creation commands within the code. Second, as shown in step 202B of FIG. 2B, static analyzer module 108A analyzes the code and determines portions of the PUT where threads will be running concurrently. This can be accomplished by searching for tasks of each of the threads. Third, as shown in step 202C of FIG. 2B, the static analyzer module 108A analyzes portions of code where the threads will be running concurrently. This can be accomplished by searching for portions of the threads that share a common variable. This analysis may include determining blocks of code that will produce interleavings between the threads due to shared variables when executed, identifying invariants (variables that do not change over multiple program steps), identifying redundant interleavings that will be produced due to these invariants when executed, and generating constraints based on the invariants and interleavings. These logical constraints may indicate of the values (e.g. exact values or range of values) of variables at different stages throughout the code with respect to the operation of both threads. These values are determined based on the interleavings and the invariants within the interleavings. Again, first step 202 is performed in the abstract by analyzing the threads, commands and logic within the code without actually executing the code. This type of analysis may be performed on any portion of the PUT where common variables are shared, and especially portions of code (e.g. loops) where the common variables are incremented and produce a large number of redundant interleavings due to invariants.

In the second primary step 204 of FIG. 2A, static instrumentation module 108B of automated program instrumentation system 108 performs static instrumentation to generate an instrumented equivalent version of the PUT having synchronization mechanisms (e.g. locks) placed therein at specific locations to avoid redundant program interleavings when executed by an enumerative model checker. Second primary step 204 is broken down into two sub steps as shown in FIG. 2C. For example, first, as shown in step 204A of FIG. 2C, static instrumentation module 108B retrieves the logical constraints for the blocks of code determined by static analyzer module 108A. Second, as shown in step 204B of FIG. 2C, the static instrumentation module 108B generates an instrumented PUT having a pruned state space by determining synchronization locations within the blocks of code based on the logical constraints, and by inserting locks at the synchronization locations to ensure execution of at least one of the redundant interleavings while ignoring at least one of the redundant interleavings in the blocks of code. For example, if 5 redundant interleavings are determined, the locks are placed in the code to ensure that 1 of the redundant interleavings will be executed by the model checker, while the other 4 redundant interleavings will be ignored by the model checker.

In the third primary step 206 of FIG. 2A, the instrumented PUT is input to model checker 112 which performs enumerative model checking on the instrumented PUT. Third primary step 206 is broken down into four sub steps as shown in FIG. 2D. For example, the model checker executes the instrumented PUT using a run-time scheduler as shown in step 206A of FIG. 2D. In step 206B of FIG. 2D, the model checker explores the various states of the instrumented PUT during execution. Then, in step 206C of FIG. 2D, the model checker develops a state model of the instrumented PUT, and compares the state model to model specifications provided by the user (e.g. programmer) in step 206D of FIG. 2D. This ensures that the instrumented PUT, and by extension the PUT achieve the desired functional model intended by the programmer.

A specific example of the method shown in the flowcharts of FIGS. 2A-2D will now be described with respect to FIGS. 3 and 4. This example is meant to be a non-limiting example for illustrative purposes and does not limit the method disclosed in FIGS. 2A-2D.

FIG. 3 shows an example PUT 302 that is operated on by static analyzer module 108A. Example PUT 302 is a multi-threaded concurrent program that includes two threads referred to herein as Thread 1 and Thread 2. Thread 2 executes an “if statement” that increments a variable “x” if variable “y” is greater than 3. Thread 2, executes a “for loop” that increments variable “y” through each iteration of the loop. It is evident that since Thread 1 and Thread 2 share common variable “y”, that the absence of a strict order between these two memory access events results in a data race for variable “y”. Furthermore, if PUT 302 is input directly into an enumerative model checker (e.g. DPOR) tool, 6 interleavings 304 would be explored. In interleavings 1-4, Thread 2 executes the “for loop” to increment variable “y” from 0 to 3. During interleavings 1-4, Thread 1 compares variable “y” to the value of 3 but does not increment variable “x” because variable “y” does not meet the logical condition in the “if statement”. Variable “x=0” is therefore an invariant during interleavings 1-4. However, in interleavings 5 and 6, variable “y” is incremented by Thread 2 to meet the condition of the “if statement” executed by Thread 1 at which point the variable “x” is incremented.

It is clear that interleavings 1-4 in FIG. 3 produce the same result (e.g. “y” is incremented while “x” is an invariant that is maintained), and are therefore redundant and are unnecessary for model checking purposes. In other words, these redundant interleavings all offer the same information to the model checker and are therefore unnecessary. Conventional enumerative model checking would not identify that these interleavings are redundant and would therefore wastefully execute/check all 6 interleavings.

In order to reduce processing power/time for the enumerative model checker, the disclosed solution uses a program instrumentation system 108 to perform a static analysis of the PUT to identify these redundancies and generate corresponding constraints. In general, the static analyzer module 108A analyzes the lines of code in the PUT in an abstract manner, without actually executing the PUT. For example, static analyzer module 108A may determine that based on the initial value, increment value and termination value of variable “i” in the code of the “for loop”, that PUT 302 would produce 6 interleavings when executed. Static analyzer module 108A may furthermore determine that based on the initial value and threshold value of variable “y” that the condition in the “if statement” of Thread 1 will not execute during interleavings 1-4. In other words, just by analyzing (in the abstract) the statements and parameters of the “if statement” and “for loop” in the code, static analyzer module 108A can identify interleavings 1-4 as being redundant due to invariant “x”, and interleavings 5 and 6 as being unique. Static analysis module 108A then generates constraints 402 as shown in FIG. 4. The constraints indicate the values of the variables “x” and “y” at different points within the threads. For example, the variables are initialized as x=0 and y=0. The constraints for Thread 1 are that prior to the “if statement” being executed, “y” either equals 0 if Thread 1 executes first, or equals a value in the range 1-5 if Thread 2 executes first. When the “if statement” is executed (e.g. y>3), “y” has the value 4 or 5, at which points “x” will be incremented. The constraints for Thread 2 are that prior to executing the “for loop”, the variables are still initialized as x=0 and y=0 regardless of which thread executes first. However, when the “for loop” is executed, “y” is incremented to have a value in the range 1-5.

Once the static analysis is complete and the redundant interleavings and the constraints are identified, the program instrumentation system 108 performs static instrumentation on the PUT to produce an instrumented PUT. The instrumented PUT is a modified version of the original PUT that eliminates at least one of the redundant interleavings while maintaining the overall properties of the original PUT. Based on these constraints in 402, static instrumented module 108B determines positions for inserting locks into the PUT in order to generate the instrumented PUT. For example, code 404 shown in FIG. 4 shows that for Thread 1, a lock statement is placed before the “if statement” while the unlock statement is positioned after the if statement increments “x”. Likewise, code 404 shows that for Thread 2, a lock statement is positioned before the “for loop”, while the unlock statement is positioned after the “for loop” increments “y”. These locks ensure that the code between the lock/unlock commands executes without being interrupted by the other thread (interleaving between threads does not occur inside the lock). Essentially the locks temporarily prevent concurrent execution between the threads. In addition, in Thread 2, the “for loop” threshold is reduced from 5 to 3 and “y” is incremented twice after the “for loop”. The “for loop” is modified in this manner to ensure that the first three redundant interleavings 1-3 shown in FIG. 3 are executed without interruption (without concurrent operation), while the last three interleavings 4-6 (one redundant interleaving and two unique interleavings) are susceptible to concurrent operation for model checking purposes. In other words, in the instrumented PUT, “y” will automatically increment from 0-3 under the protection of the lock and then the last two incrementations of “y” after the “for loop” are susceptible to concurrent operation with the incrementation of “x”.

The effects of the instrumented PUT are as follows. When the instrumented PUT is input to an enumerative model checker 112, the locks ensure that at least one of the redundant interleavings (e.g. interleaving 4) shown in FIG. 3 is executed and evaluated by the model checker along with the unique interleavings 5 and 6 shown in FIG. 3. In contrast, interleavings 1-3 are not evaluated because the “for loop” executes uninterrupted by Thread 1 due to the lock. The result is that the important interleavings are evaluated by the model checker while also reducing the number of processing steps and therefore processing time, while also preserving the behavior of the original PUT. It is noted that any number of the redundant interleavings can be ignored as long as at least one of the redundant interleavings is checked by the model checker.

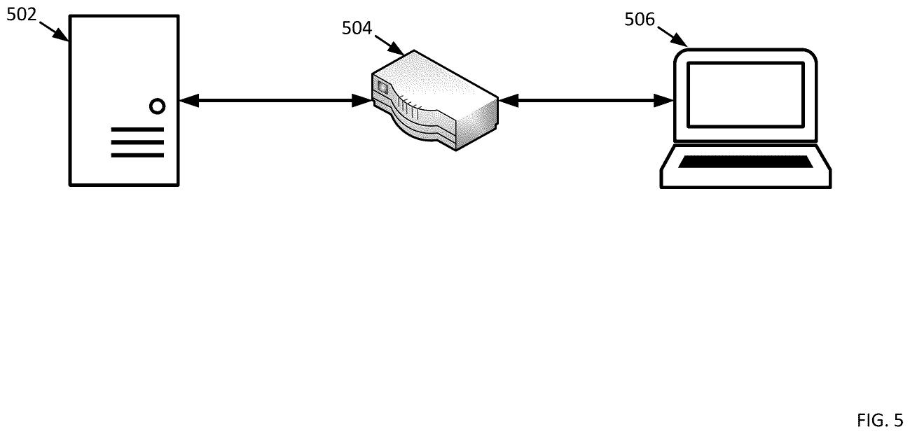

FIG. 5 shows a diagram of hardware for implementing the automated program instrumentation system and methods in FIGS. 1-4. For example, the model checking software, PUT and instrumented PUT can be stored/executed solely on computer 506. In other words, computer 506 (operated by the programmer) may be a standalone system for developing and model checking the PUT. In another example, the model checking software, PUT and instrumented PUT can be stored/executed on a combination of server 502 and computer 506 which may be in communication with each other via networking hardware such as router 504. In this example, server 502 may store the PUT, while the computer 506 performs the model checking, or vice versa. In either example, the steps of the automated programming instrumentation system described in FIGS. 1-4 may be executed. It is noted that computer 506, server 502 and router 504 may comprise devices such as processors and memory devices to support their function.

It is noted that although program instrumentation system 108 performs the static analysis and instrumentation with a focus on redundant interleavings, system may also be extended to prune non-redundant interleavings from the PUT. For example, program instrumentation system 108 may identify non-redundant interleavings having a lesser likelihood of reaching the error state. Since these non-redundant interleavings having a lesser likelihood of reaching the error state, they can be pruned from the PUT. Thus, once identified, these non-redundant interleavings are pruned in the manner described above (e.g. placing locks based on logical constraints), thereby reducing the search space at a calculated cost of soundness. In other words, a calculated risk is taken by pruning these states.

It is noted that aspects of the present disclosure may be implemented in hardware or software or a combination of hardware and software. One example embodiment described herein may be implemented as a program product for use with a computer system. The program(s) of the program product define functions of the example embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed example embodiments, are example embodiments of the present disclosure.

While the foregoing is directed to example embodiments described herein, other and further example embodiments may be devised without departing from the basic scope thereof. It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for model checking a program, the method including:
performing, by a processor, static analysis of source code of the program to inductively determine at least one invariant present in interleavings of the program; and
performing, by the processor, static instrumentation of the source code of program to generate an instrumented equivalent version of the program, the instrumented equivalent version of the program comprising locks to avoid execution of a subset of the interleavings corresponding to the at least one invariant,
wherein the instrumented equivalent version of the program is configured for enumerative model checking that avoids execution of the subset of the interleavings.

2. The method of claim 1, further comprising:
positioning, by the processor, the locks in the source code to avoid execution of a redundant subset of the interleavings during the enumerative model checking.

3. The method of claim 2, further comprising:
executing, by the processor, the enumerative model checking of at least one interleaving of the redundant subset of the interleavings, while avoiding remaining interleavings of the redundant subset of the interleavings.

4. The method of claim 1,
wherein the interleavings and the at least one invariant result from thread interactions in the program.

5. The method of claim 1, further comprising:
generating, by the processor, the instrumented equivalent version of the program by inserting the locks into the source code for multiple threads executing in the program to avoid execution of the subset of the interleavings.

6. The method of claim 1, further comprising:
positioning, by the processor, the locks in the source code to filter redundant sub-trees of a search space introduced by the subset of the interleavings during the enumerative model checking.

7. The method of claim 1, further comprising:
performing, by the processor, the static instrumentation of shared variables between threads in the source code of the program to position the locks in positions to avoid execution of a subset of the interleavings caused by the shared variables in the source code.

8. The method of claim 1, further comprising:
performing, by the processor, enumerative model checking of the instrumented equivalent version of the program by driving execution of the instrumented equivalent version of the program with a run-time scheduler.

9. The method of claim 8, further comprising:
performing, by the processor, the enumerative model checking by executing dynamic partial order reduction (DPOR) on the instrumented equivalent version of the program.

10. The method of claim 1, further comprising:
positioning, by the processor, the locks in the source code based on constraints due to the at least one invariant in the interleavings.

11. A system for model checking a program, the system including:
a memory device storing source code of a program; and
a processor configured to:
in response to instructions to execute the model checking program, retrieve the source code of the program from the memory device;
perform static analysis of the source code of the program to inductively determine at least one invariant present in interleavings of the program; and
perform static instrumentation of the source code of program to generate an instrumented equivalent version of the program, the instrumented equivalent version of the program comprising locks to avoid execution of a subset of the interleavings corresponding to the at least one invariant,
wherein the instrumented equivalent version of the program is configured for enumerative model checking that avoids execution of the subset of the interleavings.

12. The system of claim 11,
wherein the processor is further configured to position the locks in the source code to avoid execution of a redundant subset of the interleavings.

13. The system of claim 12,
wherein the processor is further configured to execute the enumerative model checking of at least one interleaving of the redundant subset of the interleavings, while avoiding remaining interleavings of the redundant subset of the interleavings.

14. The system of claim 11,
wherein the processor is further configured to perform the static analysis of source code of the program to inductively determine the at least one invariant resulting from thread interactions in the program.

15. The system of claim 11,
wherein the processor is further configured to generate the instrumented equivalent version of the program by inserting the locks into the source code for multiple threads executing in the program to avoid execution of the subset of the interleavings.

16. The system of claim 11,
wherein the processor is further configured to position the locks in the source code to filter redundant sub-trees of a search space introduced by the subset of the interleavings during the enumerative model checking.

17. The system of claim 11,
wherein the processor is further configured to perform the static instrumentation of shared variables between threads in the source code of the program to position the locks in positions to avoid execution of a subset of the interleavings caused by the shared variables in the source code.

18. The system of claim 11,
wherein the processor is further configured to perform the enumerative model checking of the instrumented equivalent version of the program by driving execution of the instrumented equivalent version of the program with a run-time scheduler.

19. The system of claim 18,
wherein the processor is further configured to perform the during the enumerative model checking by executing dynamic partial order reduction (DPOR) on the instrumented equivalent version of the program.

20. The system of claim 11,
wherein the processor is further configured to position the locks in the source code based on constraints due to the at least one invariant in the interleavings.
